(19) United States
(12) Patent Application Publication
(10) Pub. No.: US 2020/0175516 A1
(43) Pub. Date: Jun. 4, 2020

(54) FRICTIONLESS PAYMENT AUTHORIZATION

(71) Applicant: International Business Machines Corporation, Armonk, NY (US)

(72) Inventors: Craig M. Trim, Ventura, CA (US); Mauro Marzorati, Lutz, FL (US); Victor Povar, Vancouver (CA); Adam Lee Griffin, Dubuque, IA (US)

(21) Appl. No.: 16/203,810

(22) Filed: Nov. 29, 2018

(51) Int. Cl. G06Q 20/40; G06Q 20/20

(52) U.S. Cl. CPC G06Q 20/4016; G06Q 20/208; G06Q 20/204; G06Q 20/4014

(57) ABSTRACT

A method, and associated computer system and computer program product, for video compression that includes generating a risk factor score for a customer, the risk factor score related to a predicted ability of the customer to pay at a vendor, setting a purchase threshold amount for the customer at the vendor based on the generated risk factor score, receiving an indication that the customer intends to conduct at least one transaction at the vendor, determining if the at least one transaction intended to be made by the customer meets a purchase threshold amount, and transmitting a notification to a customer device in response to the determining if the at least one transaction intended to be made by the customer meets the purchase threshold amount.

### TECHNICAL FIELD

The present invention relates to systems and methods of frictionless payment authorization. More specifically, the invention relates to systems and methods of reducing friction in retail while accounting for store shrinkage.

### BACKGROUND

Checkout processes anchored by friction mechanisms are standard in retail stores. Friction checkout systems include checkout lines that requiring customer to employee interaction at checkout and make deliberate payments. Friction has been found to hinders sales. Friction checkout arrangements are seen as a necessary evil to combat stock shrinkage. Strategies are currently being developed to reduce friction at checkout as much as possible to create a more attractive buying experience for customers. The amount of friction at a given retail outlet today is often commensurate with factors such as the value of the merchandise being sold, location of the retail outlet, customer profile, and the like.

### SUMMARY

An embodiment of the present invention relates to a method, and associated computer system and computer program product, for frictionless payment authorization. One or more processors of a computing system generate a risk factor score for a customer, the risk factor score related to a predicted ability of the customer to pay at a vendor. A purchase threshold amount for the customer at the vendor is set based on the generated risk factor score. An indication that the customer intends to conduct at least one transaction at the vendor is received. It is determined if the at least one transaction intended to be made by the customer meets a purchase threshold amount. A notification to a customer device is transmitted in response to the determining if the at least one transaction intended to be made by the customer meets the purchase threshold amount.

### BRIEF DESCRIPTION OF THE DRAWINGS

FIG. 1 depicts a block diagram of a system for frictionless payment authorization, in accordance with embodiments of the present invention.

FIG. 2 depicts a shopping cart, in accordance with embodiments of the present invention.

FIG. 3 depicts a flow chart of a method for frictionless payment authorization, capable of being implemented by the system for frictionless payment authorization of FIG. 1, in accordance with embodiments of the present invention.

FIG. 4 depicts a flow chart of a method for frictionless payment notification, capable of being implemented by the system for frictionless payment authorization of FIG. 1, in accordance with embodiments of the present invention.

FIG. 5 depicts a flow chart of a method for frictionless payment authorization, capable of being implemented by the system for frictionless payment authorization of FIG. 1, in accordance with embodiments of the present invention.

FIG. 6 depicts a block diagram of an exemplary computer system that may be included in the system for frictionless payment authorization of FIG. 1, capable of implementing methods for frictionless payment authorization of FIGS. 3-5, in accordance with embodiments of the present invention.

FIG. 7 depicts a cloud computing environment, in accordance with embodiments of the present invention.

FIG. 8 depicts abstraction model layers, in accordance with embodiments of the present invention.

### DETAILED DESCRIPTION

Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure. A more complete understanding of the present embodiments and advantages thereof may be acquired by referring to the following description taken in conjunction with the accompanying drawings, in which like reference numbers indicate like features.

As a preface to the detailed description, it should be noted that, as used in this specification and the appended claims, the singular forms “a”, “an” and “the” include plural referents, unless the context clearly dictates otherwise.

Disclosed herein are frictionless payment methods and systems that reduce or eliminate stock shrinkage. The present invention seeks to improve shopping systems generally by allowing brick and mortar stores to achieve a transparent and controlled frictionless checkout process without increasing vendor risk. The present invention is configured to control risk in the absence of physical barriers at a store checkout. The present invention seeks to expand the use of frictionless checkout by vendors by providing vendors with the ability to improve the shopping experience without drawbacks encountered with prior art systems. When employed, the present invention will enhance and improve shopping experience for all consumers.

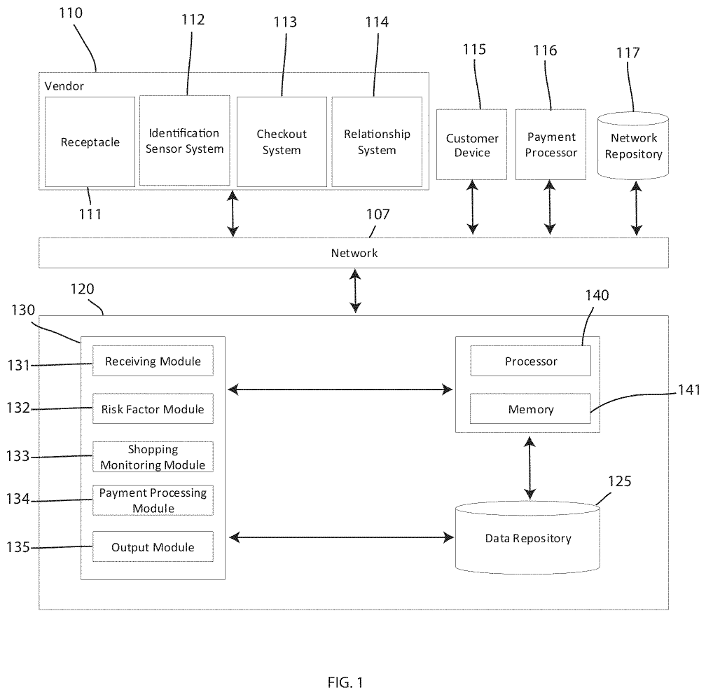

FIG. 1 depicts a block diagram of a system for frictionless payment authorization 100, in accordance with embodiments of the present invention. Embodiments of the system for frictionless payment authorization 100 may be conducted by a computer system 120, as shown in FIG. 1. Embodiments of the computer system 120 may be a computer system, a computer, a server, one or more servers, a cloud computing device, a hardware device, a remote server, and the like. In some embodiments, the computer system 120 may be directly connected to or integrated into one or more vendor systems such that the system operates in a local environment. The system for frictionless payment authorization 100 may also be referred to as a computer system, a system for frictionless shopping, a system for reducing stock shrinkage, a system for reducing risk for vendors employing frictionless checkout, and the like.

An embodiment of the system for frictionless payment authorization 100 is shown including a vendor location 110 which includes a receptacle 111, an identification sensor system 112, a checkout system 113, and a relationship system 114, communicatively coupled to the computer system 120 of the system for frictionless payment authorization 100 over a network 107. The system for frictionless payment authorization 100 further includes a customer device 115, a payment processor system 116 and a network repository 117 coupled to the computer system 120 of the system for frictionless payment authorization 100 over the network 107. Each of the vendor location 110, the receptacle 111, the identification sensor system 112, the checkout system 113, the relationship system 114, the customer device 115, the payment processor system 116, and the network repository 117 each represent a plurality or a single one of the given element 111, 112, 113, 114, 115, 116, 117. Some or all of the vendor location 110, the receptacle 111, the identification sensor system 112, the checkout system 113, the relationship system 114, the customer device 115, the payment processor system 116, and the network repository 117 may be interconnected to others of these devices. While FIG. 1 shows, for example, the vendor location 110, the customer device 115, the payment processor system 116, and the network repository 117, any interconnection (e.g. non-adjacent) of elements 110, 115, 116, 117 is contemplated. Further, while each of the elements 111, 112, 113, 114, 115, 116, 117 are shown as separate features of the system for frictionless payment authorization 100, in some embodiments one or more of the elements 111, 112, 113, 114, 115, 116, 117, may be combined or contain overlapping structure and functionality (e.g. the vendor location 110 and/or checkout system 113 may include functionality or features attributed in the present description to the payment processor 116).

The vendor location 110 may be any physical retail store, a brick and mortar store, a wholesale store, a business to business vendor, or the like. The vendor location 110 may be a physical location at which physical goods are sold. The vendor location 110 may sell physical goods, services, or combinations thereof. The vendor location 110 may sell consumer goods, groceries, auto parts, prepared food, media, electronics, clothing, sporting goods, fitness goods or equipment, crafts, appliances, home improvement goods or tools, or any other type of physical goods. The vendor location 110 may be in a shopping mall, a shopping center, a standalone store, or the like.

The vendor location 110 may include a plurality of shopping receptacles, shopping carts, shopping baskets, bins, containers, or the like, such as the receptacle 111. The receptacle may be configured to be pushed by a customer and may include wheels or another mobility mechanism. The receptacle 111 may be any other device that a customer can use to facilitate the carrying of one or more goods that the customer wishes to purchase. The receptacle 111 may include a display configured to display information to a customer using the receptacle 111. The receptacle 111 may include a payment receiving mechanism or device capable of receiving payment from a customer. The receptacle 111 may further include a communication device configured to connect the receptacle 111 to the network 107 to send and receive information, such as payment information, or other information related to the identity the customer. For example, the receptacle 111 may be configured with software configured to prompt a user to provide identifying information to the receptacle such as the name of the customer, the user name or account number of the customer, or the like. The receptacle 111 may be equipped with software allowing the customer to log into a software application hosted by or otherwise promoted by the vendor location 110. The receptacle 111 may further include a status indicator device. The status indicator device may be configured to display a color, flash one or more colored lights, or the like, to indicate a status of a transaction that is in process between the customer and the vendor location 110.

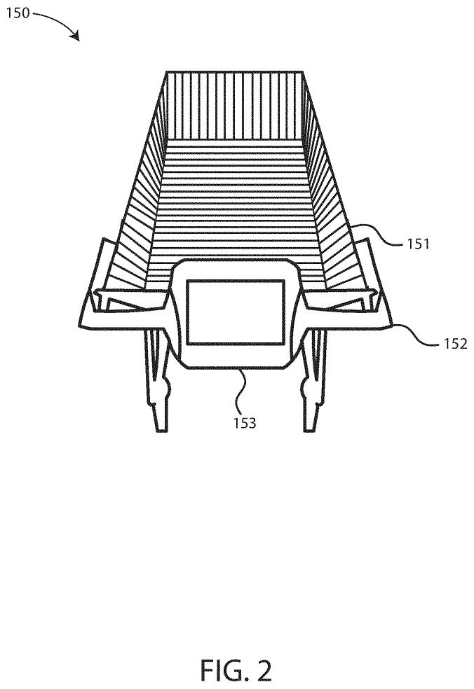

An embodiment of an exemplary receptacle 111 is shown in FIG. 2. In particular, FIG. 2 depicts a shopping cart 150, in accordance with embodiments of the present invention. The shopping cart 150 includes the mechanical features of a retail or grocery shopping cart. For example, the shopping cart 150 includes a basket 151 within which to place physical goods that the customer wishes to purchase that are being sold by the vendor location 110. The shopping cart 150 further includes a handle 152 usable by a customer to push the shopping cart 150. The shopping cart 150 further includes a frame and wheels configured to provide for mobility.

Integrated into the handle 152 of the shopping cart 150 is shown a display device 153. While the display device 153 is shown incorporated into a portion of the handle 152, the display device 153 may be coupled or otherwise attached to the shopping cart 150 in any other manner or location in other embodiments. The display device 153 may be configured to provide messages to the customer that is shopping at the vendor location 110 with the shopping cart 150. The display device 153 may further include the capability of providing an indication of status on the screen or display. For example, the screen of the display device 153 may be configured to change colors depending on the status of a transaction that is in process between the customer and the vendor. The display device 153 may be an electronic device that is capable of near field communication (NFC) such that the display device 153 is configured to receive payment from a mobile device capable of NFC transactions. The display device 153 may be configured to receive digital payment information using other mechanisms besides NFC transactions. For example, the display device 153 may alternatively be equipped with a credit card swipe reading device, credit card chip reader, RFID reader, or any other device capable of accepting payment information from a customer.

The display device 153 may include a network card or other communication mechanism to enable the display device 153 to wirelessly communicate with a network such as the network 107 or a local network of the vendor location 110. Thus, the display device 153 may be configured to send and receive transaction information to the network 107 or a local network of the vendor location 110. The display device 153 may further include a computing system that includes software configured to run one or more applications. The application of the display device 153 may be configured to obtain information from a customer, such as the name of the customer and/or any other identifying customer information. The application on the display device 153 may be configured to prompt a user to sign up for an account with the vendor location 110 and/or the computer system 120. Creating an account and logging into the account on the display device 153 may be a prerequisite for the computer system 120 and/or the system for frictionless payment authorization 100 to perform some of the functionality described herein below. For example, a user may be required to log into the display device 153 and provide identifying information, after which the system for frictionless payment authorization 100 may utilize the display device 153 to prompt the user to provide payment information. After payment information is received, the display device 153 may be further configured to provide an indication of status during shopping and during a checkout process. This status indication may be a visible status indication, but may also be a conspicuous status indicator that is only visible to the customer. The application on the display device 153 may be configured to provide other helpful shopping information to the customer during shopping.

The display device 153 or another device within the shopping cart 150 may further include the ability to determine what items or goods are placed within the basket 151. Thus, the shopping cart 150 may be configured with one or more sensors that may be configured to determine the weight, shape, or the like of objects placed therein. The shopping cart 150 may be configured to sense RF chips embedded within goods or products being sold by the vendor location 110. Thus, the shopping cart 150 may be configured to sense and communicate with the computer system 120 the goods or products placed within the shopping cart 150.

While the shopping cart 150 is shown as an exemplary embodiment of the receptacle 111, the functionality described with respect to the shopping cart 150 may be incorporated into a carrying shopping basket, container, bin, bag, or any other mechanism for carrying goods or products being sold by the vendor location 110 to customers.

Referring back to FIG. 1, the vendor location 110 is shown including the identification sensor system 112. The identification sensor system 112 includes one or more sensors or cameras located within or outside the physical location of the vendor location 110 configured to facilitate determination of customer identity. The identification sensor system 112 may include facial recognition functionality in order to confirm the identity of customers to prevent fraudulent transactions and identity theft. The identification sensor system 112 may be a security system of the vendor location 110. The identification sensor system 112 may be in communication with the computer system 120 to provide identity information, images, confirmation of identity, or the like, to the computer system 120 as customers enter the location of the vendor location 110.

The vendor location 110 is shown further including the checkout system 113. The checkout system 113 may be a frictionless checkout system that includes one or more thresholds created, for example, by one or more sensors. The one or more thresholds may be located at or close to an exit location, doorway, or the like, of the vendor location 110. For example, the one or more thresholds may be located at or proximate where traditional checkout aisles are traditionally located at a vendor. The one or more thresholds may replace or be placed in addition to traditional checkout aisles. The checkout system 113 may be configure do determine when a user intends to commit to purchasing an item or completing a transaction at the vendor location 110. The checkout system 113 may be configured to perform this determination by sensing when a customer crosses a threshold with the receptacle 111 and any goods or products located therein. The checkout system 113 may be in communication with the computer system 120, the payment processor 116, and the receptacle 111, in order to initiate a payment authorization transaction for the goods contained within the receptacle 111 when the customer crosses through the threshold.

In one embodiment, RFID chips in the receptacle 111 may be in communication with the sensors of the checkout system 113 to signal to crossing of the receptacle through the checkout system 113. Once this occurs, a communication device of the receptacle 111 may be configured to provide information pertaining to the items in the receptacle 111 that the customer wishes to purchase, prepayment information pertaining to any credit card, debit card or other payment mechanism already provided by the customer, and the like, to the payment processor 116 to finalize payment. Once finalized, the checkout system 113 may provide confirmation to the receptacle 111 so that any indicator on the receptacle may be altered according to the result of the payment authorization process. In this embodiment, the threshold of the checkout system 113 may be located at an exit of the store so that a customer is forced to walk through the threshold when exiting the vendor location 110, thereby allowing the checkout system 113 to sense the intent on the customer to complete their shopping experience and to initiate payment authorization.

The vendor location 110 is shown further including the relationship system 114. The relationship system 114 may be a computer system that is in communication to the receptacle 111 or the customer device 115. The relationship system 114 may be a system owned, operated and/or managed by the vendor location 110 and/or the computer system 120 that includes information related to the customers of the vendor location 110. The relationship system 114 may include an account creation system, an account updating system, a deal offering system, a customer preference system, or the like. The relationship system 114 may be configured to receive and retain historical information about a given customer. This historical information may be related to payments previously authorized, the amounts of such authorization, credit history, goods or products purchased, or the like. The relationship system 114 may include categories of customers that create an account with the vendor location 110, such as new customers, returning customers, preferred customers, or the like. Customers may be sorted by the relationship system 114 according to any factors, including those described above. The relationship system 114 may be configured to provide any information received and stored regarding customers of the vendor location 110 to the computer system 120 for processing in accordance to the methods for frictionless payment authorization described herein. The relationship system 114 may further include a downloadable application system that may be operated on the customer device 115.

The customer device 115 may be a mobile device such as a mobile phone, watch, tablet or the like operated by a customer of the vendor location 110. The customer device 115 may include a downloadable application hosted, operated, or managed by the vendor location 110 and/or the computer system 120. The downloadable application may provide a customer of the vendor location 110 the ability to create an account, receive offers, provide payment information, provide location information of the customer relative to the location of the vendor location 110, notify the vendor location 110 when the customer arrives, and the like. The customer device 115 may be configured to provide status updates on intended transactions of the user at the vendor location 110. For example, the customer device 115 may display the current status of a pending order, and may update regularly, as new goods or products are placed in the receptacle 111, or periodically during a shopping experience. Thus, the customer device 115 may configured to be in communication with the computer system 120 and the various other systems or devices within the system for frictionless payment authorization 100. One embodiment, the customer device 115 may include a NFC chip to enable and initiate NFC transactions with an NFC chip of the receptacle 111. The downloadable application provided by the vendor location 110 may include software configured to initiate and process transactions with the vendor location 110 in this manner, or any other appropriate manner. In one embodiment, the downloadable application may allow a customer to upload account information, such as bank account number, credit card number, debit card number, routing numbers, or the like, to facilitate transactions between the customer and the vendor location 110.

The payment processor 116 may be a bank, financial services company such as a credit card or debit card company, or the like. The payment processor 116 may be in communication with the computer system 120, the vendor location 110 (and systems or devices thereof), the customer device 115, and any other elements of the system for frictionless payment authorization 100. The payment processor 116 may include, or be in communication with credit score tracking companies. The system for frictionless payment authorization 100 may be in communication with several different payment processing companies and/or credit tracking companies in order to provide for the functionality and embodiments of the invention described herein.

The network repository 117 is a data collection area on the network 107 which may back up and save all the data transmitted back and forth between the nodes of the network 107. For example, the network repository 117 may be a data center saving and cataloging data sent between the nodes of the network 107. The network repository 117 uses this data to generate databases related to the information received. In some embodiments, a data collection center housing the network repository 117 may include an analytic module capable of analyzing each piece of data being stored by the network repository 117. Further, the computer system 120 may be integrated with or may be a component of the data collection center housing the network repository 117. In some alternative embodiments, the network repository 117 may be a local repository that is connected to the computer system 120.

The network 107 is any group of two or more computer systems linked together. The network 107 may represent, for example, the internet. The network 107 may be any type of computer network known by individuals skilled in the art. Examples of computer networks which may be embodied by the network 107 may include a LAN, WAN, campus area networks (CAN), home area networks (HAN), metropolitan area networks (MAN), an enterprise network, cloud computing network (either physical or virtual) e.g. the Internet, a cellular communication network such as GSM or CDMA network or a mobile communications data network. The architecture of the network 107 may be a peer-to-peer network in some embodiments, wherein in other embodiments, the network 107 may be organized as a client/server architecture. The computer system 120 is shown connected to vendor location 110, the customer device 115, the payment processor 116, and the network repository 117 over the network 107. The computer system 120 may also be connected via the network 107 to the particular elements within the vendor including the receptacle 111, the identification sensor system 112, the checkout system 113, and the relationship system 114.

The computer system 120 is shown including a module structure 130 that includes a receiving module 131, a risk factor module 132, a shopping monitoring module 133, a payment processing module 134, and an output module 136. A “module” herein refers to any hardware-based module, software-based module, or combination thereof. Embodiments of hardware based modules may include self-contained components such as chipsets, specialized circuitry and one or more memory devices, while a software-based module may be part of a program code or linked to the program code containing specific programmed instructions, which may be loaded in the memory device of the computer system 120. A module (whether hardware, software, or a combination thereof) may be designed to implement or execute one or more particular functions or routines.

Embodiments of the receiving module 131 include one or more components of hardware and/or software program code for obtaining, retrieving, collecting, or otherwise receiving information from the vendor location 110, the receptacle 111, the identification sensor system 112, the checkout system 113, the relationship system 114, the customer device 115, the payment processor 116, and the network repository 117. For example, the receiving module 131 may be configured to receive information from the receptacle 111 and/or the relationship system 114 when a user logs in, signs up, or the like. The receiving module 11 may further be configured to receive information from the receptacle 111 related to what goods or products have been placed into the receptacle 111 by the customer. The receiving module 131 may be configured to receive location information from the customer device 115 of the customer, or any information related to the relationship system 114 described hereinabove. The receiving module 131 may be configured to receive information related to the credit worthiness of a customer, the credit score of a customer, or the like. The receiving module 131 may further be configured to receive information related to the identity of a customer, sensed and/or collected by the identification sensor system 112 and transmitted to the computer system 120. The receiving module 131 may be configured to receive any information provided by the devices and systems described within the system for frictionless payment authorization 100.

Referring still to FIG. 1, embodiments of the computer system 120 shown further includes a risk factor module 132. Embodiments of the risk factor module 132 include one or more components of hardware and/or software program code for generating a risk factor score related to a customer. In particular, the risk factor score may be related to a predicted ability for a customer to pay at a vendor. The risk factor module 132 is configured to set a purchase threshold amount for the customer at the vendor location 110 based on the generated risk factor score. The purchase threshold amount may be a dollar amount that the system for frictionless payment transactions 100 allows a user to purchase in a frictionless manner as described herein. For example, the purchase threshold amount may be an amount that the vendor location 110 pre-approves for the customer to conduct transactions using the system for frictionless payment transactions 100. This purchase threshold amount may be provided to the customer after the customer provides the vendor location 110 a payment source that will be authorized at the end of the shopping experience of the customer. The purchase threshold amount may be an amount that is separate from the amount of credit remaining on a given credit card or account of the customer, but may instead be related to an amount the vendor location 110 has independently determined the customer is warranted based on the systems and methods described herein. The purchase threshold amount may take into account information related to the customer such as credit history, criminal records, address, amount of liquid assets of the customer, or the like. The purchase threshold amount may account for a past relationship between the customer and the vendor location 110. The purchase threshold amount may depend, for example, on algorithms accounting for the vendor. For example, the average price of the vendor goods or products may be a factor in determining the purchase threshold amount. The purchase threshold amount may consider other vendor related factors such as the location of the vendor location 110, or the risk aversion of the vendor location 110 to stock shrinkage issues.

The risk factor score created by the risk factor module 132 may account for various factors or information received by the receiving module 131 regarding a given customer. For example, the risk factor score may be based at least in part on at least one of a credit score of the customer, a payment authorizer's pre-authorization limits for a customer, bank funding availability, criminal history, credit scoring formulas, credit limits, demographic or geographic inputs, or the like. The risk factor score may further be based on a frequency of visits to the vendor location 110 by the customer, a purchase history of the customer at the vendor location 110, a participation in a rewards program of the vendor location 110, a pre-authorization credit limit of the user, or any combination(s) thereof.

The risk factor module 132 may further be configured to calculate a good will score for a given customer. The good will score may be a separate score from the risk factor score, and may reflect a type of relationship between the customer and the vendor location 110. In some embodiments, the good will score may be a score related to one or more factors which represent the relationship between the customer and the vendor location 110. For example, the good will score may depend on the creation of a digital account with the vendor on the relationship system 114 of the vendor location 110. The good will score may increase or decrease depending on the level of a person's account within the vendor relationship system 114 (i.e. an opened club card or vendor account, a customer with a preferred club card or vendor account, a defunct vendor account, or the like). The good will score may increase based on the visitation frequency of the customer to the vendor location 110, duration spent in at the vendor location 110. The good will score may further relate to historical transaction information between the customer and the vendor location 110, such as past purchases, and the like. The good will score may increase based on the number of positive transactions between the customer and the vendor. The good will score may relate to the amount of money a given customer has spent at the vendor location 110, increasing the more money a user spends at the vendor location 110. The good will score may account for the recency of transactions between the customer and the vendor location 110. Thus, the good will score may decay over time if a customer does not continue to shop at the vendor location 110. The good will score 110 may weigh each of these or other factors to generate an overall score representing the goodwill between the customer and the vendor location 110.

Thus, the good will score may relate to the history and specific relationship between the customer and the vendor location 110, while the risk factor score may relate to a calculation based on information independent of the relationship between the customer and the vendor location 110, such as for example, the credit score of the customer, the address of the customer, a reported household income of the customer, or the like. In some embodiments, the risk factor score may incorporate or factor in the good will score of the customer by, for example, increasing or decreasing the risk factor score based on the good will score. In other embodiments, the risk factor score and the good will score may be separately maintained, and the risk factor module 132 may be configured to generate a purchase threshold amount based on an algorithm that accounts for both scores. Whatever the embodiment, the purchase threshold amount created by the risk factor module 132 may account for information received by the computer system 120 that relates to both the relationship between the customer and the vendor location 110, and additionally may account for information that relates generally to the customer independent of any relationship with the vendor location 110.

The purchase threshold amount may thus be created for any customer that agrees to involvement in the system for frictionless payment authorization 100. The purchase threshold amount may be provided to the customer in an anonymous manner such that other customers or store employees may know the purchase threshold amount that has been provided by the vendor location 110 to the customer. In one embodiment, the risk factor module 132 calculates an independent risk factor score for a customer that is independent of any relationship or history with the customer. This risk factor score may then be modified by a good will score based on the relationship between the customer and the vendor location 110. The risk factor score and modified score may be represented in a dollar value representing the purchase threshold. For example, if an initial risk factor score of $400 is assigned to a given customer based on their credit history, payment authorization, etc., the customer may be provided a 25% increase based on a high good will score. Thus, the final purchase threshold determined by the risk factor module 132 for the given customer may be $500 ($400.00+0.25 ($400.00)). Embodiments of the shopping monitoring module 133 include one or more components of hardware and/or software program code for determining the status of a customer shopping experience at the vendor location 110. The shopping monitoring module 133 may be configured to determine that a customer is shopping at the vendor location 110. For example, the shopping monitoring module 133 may be configured to receive information from the customer device 115 or the receptacle 111 related to the presence of a customer at the vendor location 110. A customer may log into the device 115, which may include location tracking, or may be triggered by the customer using a Wi-Fi network of the vendor location 110. The customer may provide credential information to the receptacle 111 that the customer is shopping at the vendor location 110.

The shopping monitoring module 133 may be configured to receive an indication that the customer intends to conduct at least one transaction at the vendor location 110. For example, the receptacle 111 may provide information related to the goods or products contained therein and sensed by the receptacle 111. The shopping monitoring module 133 may create a digital shopping cart that keeps track of the items in the real shopping cart or receptacle 111 of the customer. Thus, the shopping monitoring module 133 may be configured to receive the indication from a physical receptacle 111 after the physical receptacle 111 automatically senses the presence of an item, good or service that the customer intends to purchase in the transaction. The indication may indicate that the item was placed in the physical receptacle.

The shopping monitoring module 133 may be configured to prompt a customer to input payment information such that a pre-authorization process may be initiated by the shopping monitoring module. To initiate the pre-authorization process, upon the determining that the customer is shopping at the vendor location 110, the shopping monitoring module 133 may be configured to prompt a customer, via a message to the customer device 115 or via a message on a display screen of the receptacle 111, to input payment information. If payment information has already been associated with the customer, for example, in instances that the customer has created an account at the vendor in the relationship system 114 and has associated with payment information with the created account, the pre-authorization process may include confirming previously input payment information.

Once payment information has been received, the shopping monitoring module 133 may be configured to determine whether an intended transaction to be made by the customer meets the purchase threshold amount determined by the risk factor module 132. For example, whenever the customer places a good, item or product within the receptacle 111, the receptacle may sense the item being placed in the receptacle, report this to the computer system 120, and the shopping monitoring module 133 may determine whether the combined items in the receptacle, with all current items accounted for, cost an amount that is lower than the purchase threshold amount.

The shopping monitoring module 133 may be configured to assign a status to the intended transaction. The assigned status may correspond to a word or name, a number or level, or a color. For example, there may be three possible assigned statuses: green, corresponding to when the shopping monitoring module 133 has determined that the intended transaction currently has no problems should actual checkout and payment processing be initiated; yellow, corresponding to when then shopping monitoring module 133 has determined that there is a transient problem associated with the intended transaction; or red, corresponding to when there is a permanent problem with the transaction, and checkout and payment processing would be denied. Other examples, of assigned status may include a number scale having levels 1, 2, and 3. Any appropriate status title may be created and intended transactions may be categorized into status titles created by the shopping monitoring module 133. The status titles may be provided to the output module 135 for providing information to the vendor location 110 and/or the customer device 115 or the receptacle 111 as described herein below. The shopping monitoring module 133 may be configured to continually check the status associated with any customer's shopping experience each time a new items is placed into the receptacle 111, and/or at any other appropriate predetermined intervals.

With continued reference to FIG. 1, embodiments of the computer system 120 includes a payment processing module 134. Embodiments of the payment processing module 134 include one or more components of hardware and/or software program code for initiating a payment authorization cycle in response to the computer system 120 receiving an indication that the physical receptacle has crossed a sensed threshold, such as a checkout threshold in the checkout system 113 of the vendor location 110, as described hereinabove. The payment processing module 134 may be in communication with the payment processor 116, or any entity, bank, credit or debit card company, or the like, that is remitting payment to the vendor location 110 on behalf of the customer. The payment processing module 134 may be configured to determine the final status of a transaction as the customer is crossing the sensed threshold. In one embodiment, the payment processing module 134 may be configured to finalize the at least one transaction and ensure that the transaction has a status of“no problems” prior to initiating payment authorization. The payment processing module 134 may then initiate payment processing and then confirm that the payment has concluded with the same “no problems” status after payment. In one embodiment, the payment processing module 134 may be configured to determine that the actual payment authorization had a transient problem, such as a temporary problem with a payment authorization service. The vendor location 110 may allow a customer to leave the store with items if a status associated with a temporary or transient problem is detected or found by the payment processing module 134 at payment. The vendor may be configured to keeping the transaction open, for example, and re-request authorization at a later time. The vendor location 110 may choose to prevent transactions with detected transient problems. In the event that a permanent or more serious problem is determined by the payment processing module 134, such as the transaction exceeding or not complying with the purchase threshold amount, the payment processing module 134 may be configured to initiate a system at the vendor that will result in a denial of the transaction. For example, the payment processing module 134 may be configured to initiate security measures to prevent the customer from leaving the vendor location 110. The payment processing module 134 may further be configured to receive information from the identification sensor system 112 and use this information to process and recognize the face of customers to confirm customer identity and prevent fraud or identity theft. The payment processing module 134 may be configured to confirm the identity prior to processing a requested payment by a customer.

With continued reference to FIG. 1, embodiments of the computer system 120 include an output module 135. Embodiments of the output module 135 include one or more components of hardware and/or software program code for providing outputs to the receptacle 111, such as the display device 153 of the shopping cart 150, the customer device 115, or any computer system of the vendor location 110. The output module 135 may be configured for notifying, alarming, or otherwise transmitting or providing information to the vendor location 110, the receptacle 111, the customer device 115, the payment processor 116, or any other elements of the system for frictionless payment authorization 100, as needed in accordance to the methods and functionality described herein.

In one embodiment, the output module 135 may be configured to provide color coded status updates to the user device and/or an indicating mechanism, as determined by the shopping monitoring module 133 and the payment processing module 134. For example, for transactions that are pending or intended, a “no problem” status may be indicated by the output module outputting a signal that corresponds to a green light being emitted on the receptacle 111 and/or the customer device 115. A “transient problem” status may be indicated by the output module outputting a signal that corresponds to a yellow light being emitted on the receptacle 111 and/or the customer device 115. A “permanent or serious problem” status may be indicated by the output module outputting a signal that corresponds to a red light being emitted on the receptacle 111 and/or the customer device 115. Other outputs may be provided by the output module 135, corresponding to status, such as different colors, different numbers being displayed, or different messages being displayed. In other embodiments, the status' output by the output module 135 may be provided to the customer and/or the vendor location 110 in a conspicuous manner that protects the privacy of the customer. For example, the information related to the purchase threshold amount or shopping status may be provided on the display in a manner that does not notify other customers of a given customer's shopping status, or purchase threshold amount. Further, the status of a given customer may be provided to a system of the vendor 110 that is not readily visible to other customers or employees. In one embodiment, an employee located near the exit threshold of the system for frictionless payment authorization 100 may have a display device that provides status information related to customers leaving the store through the exit threshold, enabling the employee to anonymously monitor the status of customers without other customers readily knowing status of each customer.

The output module 135 may further be configured to prompt customers in establishing a customer profile in the relationship system 114 of the vendor location 110. The output module 135 may be configured to prompt the user in providing payment information. The output module 135 may be configured to provide the customer device 115 and/or the receptacle 111 with any appropriate messages to facilitate the methods and functionality described herein.

Referring still to FIG. 1, embodiments of the computer system 120 may be equipped with a memory device 142 which may store information being used by the module structure 130 of the computer system 120. The computer system 120 may further be equipped with a processor 141 for implementing the tasks associated with the system for frictionless payment authorization 100 and perform processing associated with the functionality of the module structure 130.

While the computer system 120 is shown as a separate entity connected to the vendor location 110 by the network 107, in other embodiments, the computer system 120 may be integrated into a system that is local, run by, operated by, or managed directly by the vendor location 110. The computer system 120 may be a cloud service offered to the vendor run and operated by a separate entity to the vendor location 110, or may be a system that is directly operable by the vendor location 110.

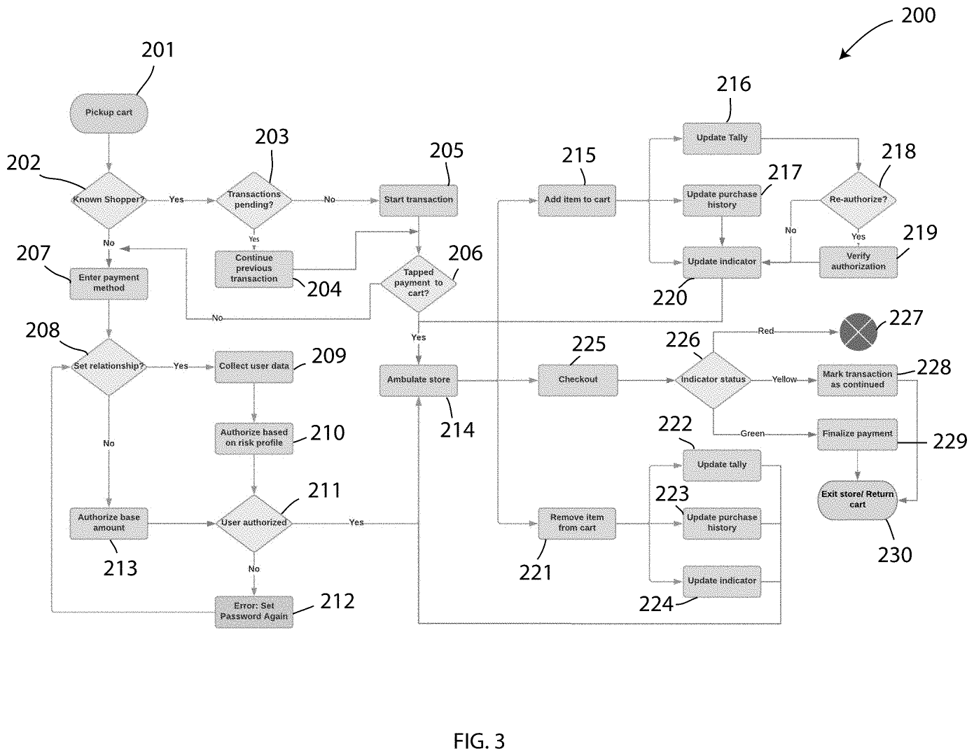

FIG. 3 depicts a flow chart of a method 200 for frictionless payment authorization, capable of being implemented by the system for frictionless payment authorization of FIG. 1, in accordance with embodiments of the present invention. The method 200 includes a first step 201 of a customer picking up a cart, such as the shopping cart 150. The method 200 then includes the step 202 of determining whether the customer is a known shopper. The step 202 may be accomplished by the customer interacting with the relationship system 114 of the vendor location 110. If the step 202 determines that the customer is a known shopper, the method 200 includes a step 203 of determining whether a transaction is currently pending, in process, or intended by the customer. For example, if the customer was allowed to leave the vendor on their previous visit with a transient problem at checkout with payment authorization, the step 203 includes determining that the transaction remains pending followed by a step 204 of continuing the previous transaction. If it is determined that there is no transactions pending, the method 200 includes a step 205 of starting a new transaction.

Whatever the transaction old or new, the method 200 includes a step 206 of determining if a customer has input a NFC and/or tapped payment with the cart 150 or receptacle 111 and initiating payment authorization through an NFC transaction with a reader associated with the cart or receptacle 111. The payment authorization may be akin to opening a tab, or pre-paying at a self-service fueling station. If payment authorization goes through for a known shopper having a known risk factor score and a known purchase threshold amount, the method 200 may include a step 214 of moving around the vendor and shopping.

If the known customer does not use an NFC tap transaction, the method may include a step 207 of entering a new payment method by the known customer. The step 207 may also occur in the event that step 202 determines that the shopper was unknown to the vendor, or a new customer. Step 207 includes the customer providing new payment information to the system, and the system re-determining the known user's risk factor score, purchase threshold amount, and the like, which might be impacted by the new form of payment used by the customer.

After payment information is provided in step 207, the method 200 includes the step 208 of determining whether a relationship exists between the vendor location 110 and the customer. If no relationship exists, the method 200 includes the step 213 of authorizing a base amount for an intended transaction. If a relationship exists, the method 200 includes a step 209 of collecting or reviewing user data related to that relationship. The relationship information may be found and stored in the relationship system 114 of the vendor location 110. Once relationship information is taken into account the method includes a step 210 of authorizing an amount for an intended transaction based on a risk profile or risk factor score. Once an authorized purchase threshold amount is determined, the method 200 may include a step 211 of obtaining authorization for the purchased threshold amount determined in steps 210, 213. If the authorize receives an error in step 212, the process restarts at step 208. If the authorization completes, the method includes allowing the user to move about the store and shopping in a step 214.

When the customer is walking around the store at the step 214, the method 200 includes a step 215 of the customer adding an item to the cart. If an item is added to the cart in step 214, the method includes a step 216 of updating a tally of what is in the cart within the computer system, a step 217 of updating a purchase history in the relationship system of the store associated with the customer, and a step 220 of updating a status of the transaction and/or an indicator on the cart or user device, by the computer system. A determination step 218 of determining whether re-authorization is necessary occurs when an item is added to the cart for re-authorizing a transaction with a payment entity, such as a bank, credit card or debit card company. If re-authorization is necessary, the step 218 is followed by actually verifying authorization in a step 219. The indicator may be updated at step 220 depending on the result of the authorization in step 219 with either an indication of a problem, no problem, or a transient problem.

Similarly, when the customer is walking around the store, the method 200 includes a step 221 of the customer removing an item from the cart. When an item is removed from the cart, the method 200 includes a step 222 of updating a tally of what is in the cart within the computer system, a step 223 of updating a purchase history in the relationship system of the store associated with the customer, and a step 220 of updating a status of the transaction and/or an indicator on the cart or user device, by the computer system. For example, if items are removed from the cart, the status may change from having problems because the amount exceeds the purchase threshold, to having no problems because the removed items brings the proposed or intended transaction below the threshold.

When the customer has completed shopping, the method includes a step 225 of performing checkout. The checkout process will review the indicator status at a step 226 of the intended transaction. If the status is “green”, or having no problems, the method 200 includes a step 229 of finalizing payment in accordance with the amount in the cart that has already been authorized. The method 200 then includes a step 230 of exiting the store by the customer, and returning the cart to a cart repository or cart charging station. If the status is “red”, or having a permanent problem, the method includes a step 227 of preventing the transaction from being complete and preventing the customer from leaving with the items in the cart. If the status is “yellow”, or having a transient problem, the method 200 includes a step 228 of marking the transaction as continued, followed by the step 230 of exiting the store by the customer, and returning the cart to a cart repository or cart charging station.

While not shown, systems and methods described herein may include offering a customer, by the computer system, additional sources of credit in response to a status of an intended transaction to be problematic. For example, if a user only has approval for an amount that becomes exceeded by the cost of items within a cart or receptacle, the computer system 120 may make this determination and offer the customer additional sources of credit through, for example, payment processors 116 that are partnered with the vendor location 110 and/or the computer system 120.

Furthermore, the systems and methods described herein may include linking multiple shopping receptacles, carts or the like, to a single customer account or frictionless payment authorization experience. This may allow for a customer to have a larger shopping experience. The receptacles may use NFC to link together, for example requiring the customer to place the carts proximate each other and click, press, say or otherwise activate a command that performs the linking. Any number of carts may be linked together.

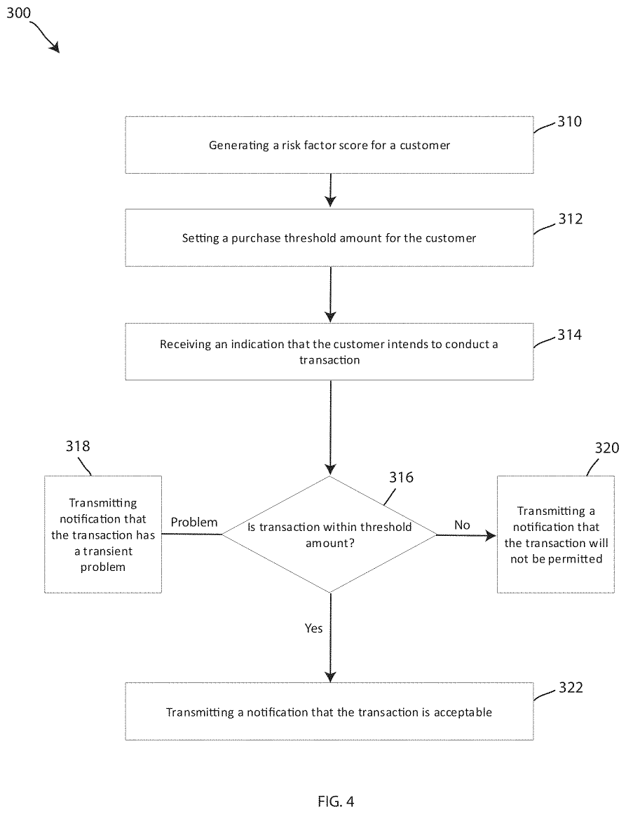

FIG. 4 depicts a flow chart of a method 300 for frictionless payment notification, capable of being implemented by the system for frictionless payment authorization of FIG. 1, in accordance with embodiments of the present invention. The method 300 includes a step 310 of generating a risk factor score for a customer. The risk factor score may be at least in part based on one or more of a credit score of the customer, a frequency of visit to the vendor by the customer, a purchase history of the user at the vendor, a participation in a rewards program of the vendor by the customer and/or a pre-authorization credit limit of the customer. The step 310 may include calculating, for example, a good will score for the customer in addition to the risk factor score, reflecting a type of relationship between the customer and the vendor. The good will score may facilitate in the calculating of the generated risk factor score, or may facilitate in the later steps of setting purchase threshold amounts.

The method 300 includes a step 312 of setting a purchase threshold amount for the customer. The setting the purchase threshold amount step 312 may be based on the generated risk factor score for the customer. The method 300 includes a step 314 of receiving an indication that the customer intends to conduct at least one transaction at the vendor. The step 314 may include the indication being from a physical receptacle such as the receptacle 111 or the shopping cart 150 that is configured to automatically sense the presence of an item that the customer intends to purchase in a transaction. The indication may correspond to an indication that the item was placed in the physical receptacle. The indication may not be an indication that the customer wishes to initiate a checkout process, but simply an indication that the customer intends to initiate a transaction to purchase the item or items currently in the receptacle.

The method 300 includes a determining step 316 of determining whether the transaction intended to be made by the customer meets a purchase threshold amount, or exceeds the amount. If the transaction is not within the purchase threshold amount, the method 300 includes a step 320 of transmitting a notification that the transaction will not be permitted. If the transaction is within the purchase threshold amount, the method 300 includes a step 322 of transmitting a notification that the transaction is acceptable. If the transaction is determined to have a transient problem, the method 300 includes a step 318 of transmitting a notification that the transaction has a transient problem. These transmitted notifications may be provided to a device of the customer, or to an indicator associated with, attached to, or otherwise located on the receptacle 111.

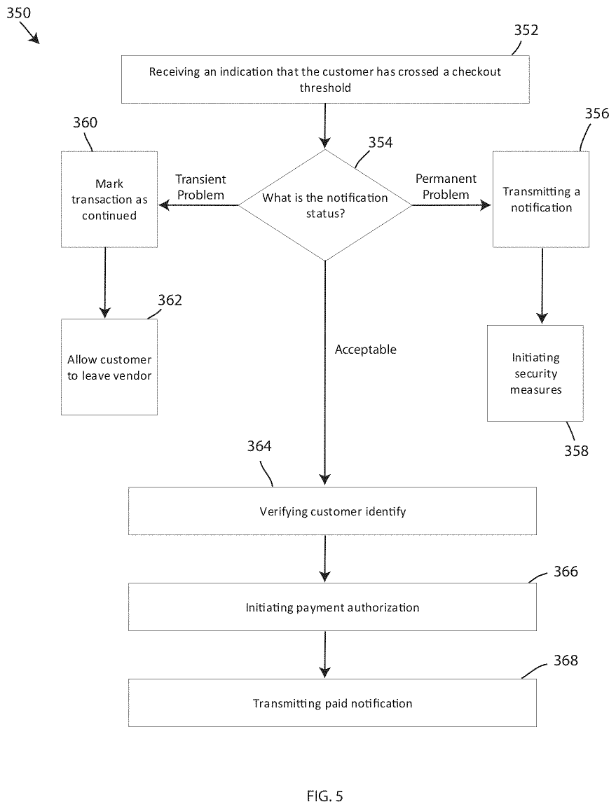

FIG. 5 depicts a flow chart of a method 350 for frictionless payment authorization, capable of being implemented by the system for frictionless payment authorization of FIG. 1, in accordance with embodiments of the present invention. The method 400 includes steps for processing a checkout in accordance with the systems and functionality described herein. The method 350 may include a step 352 of receiving an indication that the customer has crossed a checkout threshold with one or more products, items or goods within a receptacle. The method 350 includes a step 354 of determining the notification status of the intended transaction.

If the notification status is determined, for example, to be acceptable, or without any problems, the method 350 includes a step 364 of verifying the identity of the customer, a step 366 of initiating payment authorization 366, and a step 360 of transmitting a notification or receipt to the customer device or to a display device of the receptacle that payment has been received and confirmed.

If the notification status is determined to be indicative of a transient problem, the method 350 includes the step 360 of marking the transaction as in process or to be continued later. The method 350 may then include a step 362 of allowing the customer to leave the vendor. The method 350 may then include initiating the payment authorization process for the transaction at a later time when the transient problem is no longer occurring.

If the notification status is determined to be indicative of a permanent problem, the method 350 includes the step 356 of transmitting a permanent problem notification. For example, such a notification may come in the form of a red indicator associated with a display on the shopping cart 150 or receptacle 111. The method 350 may then include the step of initiating security measures 358 should the customer decide to try to leave with the item or items in the receptacle 111. The method 350 may further include transmitting a notification to the vendor that an intended transaction or checkout process resulted in a permanent problem.

In one exemplary embodiment consistent with the methods and systems described herein, the risk factor module 132 may be presented with information pertaining to a customer that is determined to be a new customer, having poor credit, with no available bank funds, and no further information is provided. In this example, the risk factor module 132 may determine that the risk factor score makes the new customer ineligible for participation in a frictionless shopping experience. The risk factor module 132 may determine that the risk factor score is too high, and there is no good will generated by the new customer that would change such an assessment. In this embodiment, the computer system 120 may be configured to provide instructions to the customer to access a method for frictionless payment authorization in the future. The customer may shop at the vendor location 110 in a typical manner with a typical checkout method.

In another embodiment, the risk factor module 132 may be presented with information pertaining to another customer that is a returning customer having a club account with the vendor. The returning customer has a long history with the retailer with purchases that have been approved in the past. The returning customer has credit depth to use and bank funding authorization. Based on this received information about the returning customer, the risk factor module 132 may be configured to offer the customer frictionless incremental and/or liquid transactions with approval up to a predetermined high amount, for example, $1000.00. In this same example, if the returning customer adds a $1200.00 home improvement item, the system may initiate a yellow light on the transaction, as the buyer has exceeded the predetermined approval amount of $1000.00. This status determination may be provided to the customer in a conspicuous manner so as to not notify other customers of the status. The computer system 120, via for example, the display on the receptacle or cart, or via the customer's mobile device, may offer the returning customer with an additional line of credit for the extra $200.00. If the returning customer accepts, the transaction or shopping experience may once again have a “no problem” or green light status, which may be provided in a visible or conspicuous manner.

In a third example, the risk factor module 132 may be presented with information pertaining to a customer without a club card that has only shopped periodically at the vendor location 110. The new customer has a bad credit history but has satisfactory bank funds. The customer is determined to typically buy low cost goods. The computer system may be configured to offer the customer frictionless incremental and/or liquid transactions with approval up to a predetermined lower amount, for example, $125.00. If this buyer adds a good with a price of $800.00 to the cart, the risk factor module 132 may recalculate a risk factor score for the transaction and place the transaction in a problem category. This is because the buyer has increased well beyond the approved amount of $125.00 and the store will not extend a credit offer up to this amount for the customer. The problem status may be conspicuously provided to the customer and/or the vendor 110 in the manner described herein above.

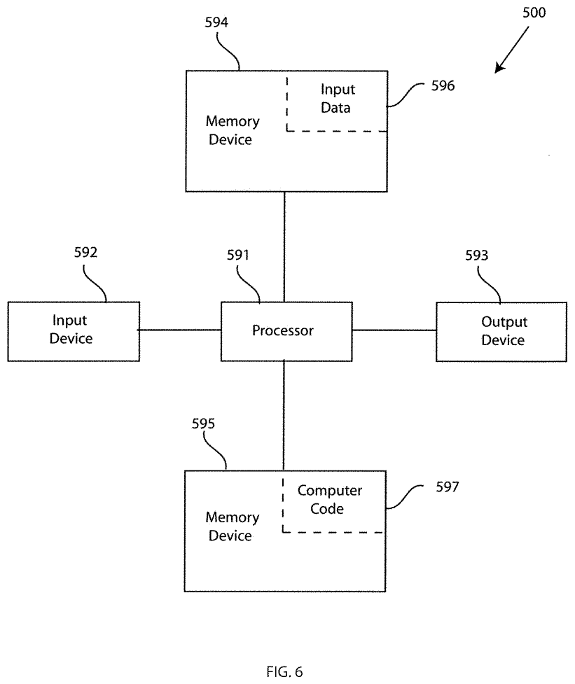

FIG. 6 illustrates a block diagram of a computer system that may representative of any computer or computer system within the system for frictionless payment authorization 100 of FIG. 1, capable of implementing methods for frictionless payment authorization of FIGS. 3-5, in accordance with embodiments of the present invention. The computer system 500 may generally comprise a processor 591, an input device 592 coupled to the processor 591, an output device 593 coupled to the processor 591, and memory devices 594 and 595 each coupled to the processor 591. The input device 592, output device 593 and memory devices 594, 595 may each be coupled to the processor 591 via a bus. Processor 591 may perform computations and control the functions of computer 500, including executing instructions included in the computer code 597 for the tools and programs capable of implementing a method for frictionless payment authorization, in the manner prescribed by the embodiments of FIGS. 3-5 using the system for frictionless payment authorization 100 of FIG. 1, wherein the instructions of the computer code 597 may be executed by processor 591 via memory device 595. The computer code 597 may include software or program instructions that may implement one or more algorithms for implementing the methods for frictionless payment authorization, as described in detail above. The processor 591 executes the computer code 597. Processor 591 may include a single processing unit, or may be distributed across one or more processing units in one or more locations (e.g., on a client and server).

The memory device 594 may include input data 596. The input data 596 includes any inputs required by the computer code 597. The output device 593 displays output from the computer code 597. Either or both memory devices 594 and 595 may be used as a computer usable storage medium (or program storage device) having a computer readable program embodied therein and/or having other data stored therein, wherein the computer readable program comprises the computer code 597. Generally, a computer program product (or, alternatively, an article of manufacture) of the computer system 500 may comprise said computer usable storage medium (or said program storage device).

Memory devices 594, 595 include any known computer readable storage medium, including those described in detail below. In one embodiment, cache memory elements of memory devices 594, 595 may provide temporary storage of at least some program code (e.g., computer code 597) in order to reduce the number of times code must be retrieved from bulk storage while instructions of the computer code 597 are executed. Moreover, similar to processor 591, memory devices 594, 595 may reside at a single physical location, including one or more types of data storage, or be distributed across a plurality of physical systems in various forms. Further, memory devices 594, 595 can include data distributed across, for example, a local area network (LAN) or a wide area network (WAN). Further, memory devices 594, 595 may include an operating system (not shown) and may include other systems not shown in FIG. 6.

In some embodiments, the computer system 500 may further be coupled to an Input/output (I/O) interface and a computer data storage unit. An I/O interface may include any system for exchanging information to or from an input device 592 or output device 593. The input device 592 may be, inter alia, a keyboard, a mouse, etc. The output device 593 may be, inter alia, a printer, a plotter, a display device (such as a computer screen), a magnetic tape, a removable hard disk, a floppy disk, etc. The memory devices 594 and 595 may be, inter alia, a hard disk, a floppy disk, a magnetic tape, an optical storage such as a compact disc (CD) or a digital video disc (DVD), a dynamic random access memory (DRAM), a read-only memory (ROM), etc. The bus may provide a communication link between each of the components in computer 500, and may include any type of transmission link, including electrical, optical, wireless, etc.

An I/O interface may allow computer system 500 to store information (e.g., data or program instructions such as computer code 597) on and retrieve the information from computer data storage unit (not shown). Computer data storage unit includes a known computer-readable storage medium, which is described below. In one embodiment, computer data storage unit may be a non-volatile data storage device, such as a magnetic disk drive (i.e., hard disk drive) or an optical disc drive (e.g., a CD-ROM drive which receives a CD-ROM disk). In other embodiments, the data storage unit may include a knowledge base or data repository 125 as shown in FIG. 1.

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider that offers to deploy or integrate computing infrastructure with respect to systems and methods for frictionless payment authorization. Thus, an embodiment of the present invention discloses a process for supporting computer infrastructure, where the process includes providing at least one support service for at least one of integrating, hosting, maintaining and deploying computer-readable code (e.g., computer code 597) in a computer system (e.g., computer 500) including one or more processor(s) 591, wherein the processor(s) carry out instructions contained in the computer code 597 causing the computer system to provide a system for frictionless payment authorization. Another embodiment discloses a process for supporting computer infrastructure, where the process includes integrating computer-readable program code into a computer system including a processor.

The step of integrating includes storing the program code in a computer-readable storage device of the computer system through use of the processor. The program code, upon being executed by the processor, implements a method for frictionless payment authorization. Thus, the present invention discloses a process for supporting, deploying and/or integrating computer infrastructure, integrating, hosting, maintaining, and deploying computer-readable code into the computer system 500, wherein the code in combination with the computer system 500 is capable of performing a method for frictionless payment authorization.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

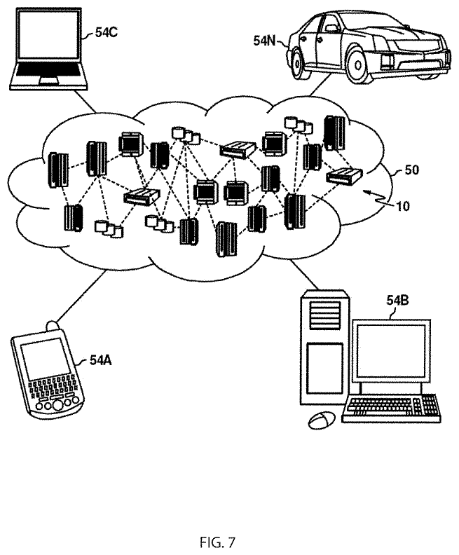

Referring now to FIG. 7, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A, 54B, 54C and 54N shown in FIG. 7 are intended to be illustrative only and that computing nodes 10 and cloud computing environment 50 can communicate with any type of computerized device over any type of network and/or network addressable connection (e.g., using a web browser).

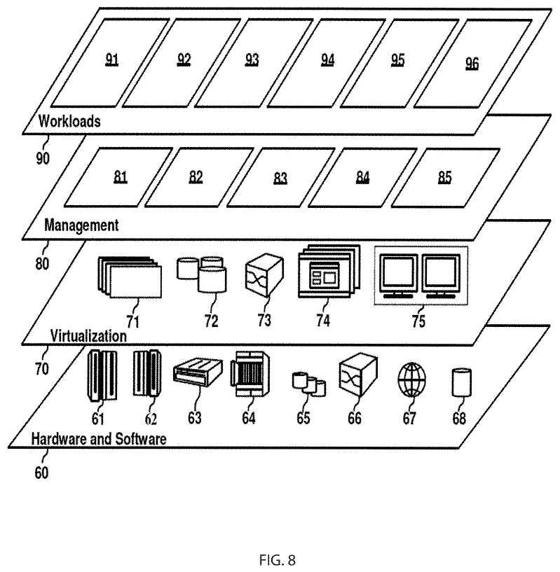

Referring now to FIG. 8, a set of functional abstraction layers provided by cloud computing environment 50 (see FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and processing related to frictionless payment authorization 96.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method comprising:
generating, by one or more processors of a computer system, a risk factor score for a customer, the risk factor score related to a predicted ability of the customer to pay at a vendor;
setting, by the one or more processors of the computer system, a purchase threshold amount for the customer at the vendor based on the generated risk factor score;
receiving, by the one or more processors of the computer system, an indication that the customer intends to conduct at least one transaction at the vendor;
determining, by the one or more processors of the computer system, if the at least one transaction intended to be made by the customer meets a purchase threshold amount; and
transmitting, by the one or more processors of the computer system, a notification to a customer device in response to the determining if the at least one transaction intended to be made by the customer meets the purchase threshold amount.

2. The computer-implemented method of claim 1, wherein the risk factor score is based at least in part on a credit score of the customer, a frequency of visit to the vendor, a purchase history of the customer at the vendor, a participation in a rewards program of the vendor, and a pre-authorization credit limit of the customer.

3. The method of claim 1, the method further comprising:
calculating, by the one or more processors of the computer system, a good will score that reflects a type of relationship between the customer and the vendor; and
facilitating, by the one or more processors of the computer system, the at least one transaction utilizing the calculated good will score.

4. The method of claim 1, further comprising:
receiving, by the one or more processors of the computer system, the indication from a physical receptacle configured to automatically sense the presence of an item that the customer intends to purchase in the at least one transaction, the indication indicating that the item was placed in the physical receptacle; and
transmitting, by the one or more processors of the computer system, the notification to a display on the physical receptacle in the form of a visible indicator viewable by the customer and employees of the vendor.

5. The method of claim 4, further comprising:
receiving, by the one or more processors of the computer system, a second indication that the physical receptacle is crossing a sensed threshold at the vendor;
initiating, by the one or more processors of the computer system, a payment authorization cycle in response to the receiving the second indication that the physical receptacle is crossing the sensed threshold; and
transmitting, by the one or more processors of the computer system, a second notification related to the status of the payment authorization cycle.

6. The method of claim 1, further comprising:
determining, by the one or more processors of the computer system, that the at least one transaction intended to be made by the customer meets the purchase threshold amount;
finalizing, by the one or more processors of the computer system, the at least one transaction; and
verifying, by the one or more processors of the computer system, an identity of the customer using information received by an identity sensing system.

7. The method of claim 1, further comprising:
determining, by the one or more processors of the computer system, that the at least one transaction intended to be made by the customer does not meet the purchase threshold amount; and
initiating security measures to prevent the customer from leaving the vendor.

8. A computer system, comprising:
one or more processors;
one or more memory devices coupled to the one or more processors; and
one or more computer readable storage devices coupled to the one or more processors, wherein the one or more storage devices contain program code executable by the one or more processors via the one or more memory devices to implement a computer-implemented method, the method comprising:
generating, by the one or more processors of the computer system, a risk factor score for a customer, the risk factor score related to a predicted ability of the customer to pay at a vendor;
setting, by the one or more processors of the computer system, a purchase threshold amount for the customer at the vendor based on the generated risk factor score;
receiving, by the one or more processors of the computer system, an indication that the customer intends to conduct at least one transaction at the vendor;
determining, by the one or more processors of the computer system, if the at least one transaction intended to be made by the customer meets a purchase threshold amount; and
transmitting, by the one or more processors of the computer system, a notification to a customer device in response to the determining if the at least one transaction intended to be made by the customer meets the purchase threshold amount.

9. The computer system of claim 8, wherein the risk factor score is based at least in part on a credit score of the customer, a frequency of visit to the vendor, a purchase history of the customer at the vendor, a participation in a rewards program of the vendor, and a pre-authorization credit limit of the customer.

10. The computer system of claim 8, the method further comprising:
calculating, by the one or more processors of the computer system, a good will score that reflects a type of relationship between the customer and the vendor; and
facilitating, by the one or more processors of the computer system, the at least one transaction utilizing the calculated good will score.

11. The computer system of claim 8, the method further comprising:
receiving, by the one or more processors of the computer system, the indication from a physical receptacle configured to automatically sense the presence of an item that the customer intends to purchase in the at least one transaction, the indication indicating that the item was placed in the physical receptacle; and
transmitting, by the one or more processors of the computer system, the notification to a display on the physical receptacle in the form of a visible indicator viewable by the customer and employees of the vendor.

12. The computer system of claim 11, the method further comprising:
receiving, by the one or more processors of the computer system, a second indication that the physical receptacle is crossing a sensed threshold at the vendor;
initiating, by the one or more processors of the computer system, a payment authorization cycle in response to the receiving the second indication that the physical receptacle is crossing the sensed threshold; and
transmitting, by the one or more processors of the computer system, a second notification related to the status of the payment authorization cycle.

13. The computer system of claim 8, the method further comprising:
determining, by the one or more processors of the computer system, that the at least one transaction intended to be made by the customer meets the purchase threshold amount;
finalizing, by the one or more processors of the computer system, the at least one transaction; and
verifying, by the one or more processors of the computer system, an identity of the customer using information received by an identity sensing system.

14. The computer system of claim 8, the method further comprising:
determining, by the one or more processors of the computer system, that the at least one transaction intended to be made by the customer does not meet the purchase threshold amount; and
initiating security measures to prevent the customer from leaving the vendor.

15. A computer program product, comprising one or more computer readable hardware storage devices storing a computer readable program code, the computer readable program code comprising an algorithm that when executed by one or more processors of a computing system implements a computer-implemented method, the method comprising:
generating, by the one or more processors of the computer system, a risk factor score for a customer, the risk factor score related to a predicted ability of the customer to pay at a vendor;
setting, by the one or more processors of the computer system, a purchase threshold amount for the customer at the vendor based on the generated risk factor score;
receiving, by the one or more processors of the computer system, an indication that the customer intends to conduct at least one transaction at the vendor;
determining, by the one or more processors of the computer system, if the at least one transaction intended to be made by the customer meets a purchase threshold amount, and
transmitting, by the one or more processors of the computer system, a notification to a customer device in response to the determining if the at least one transaction intended to be made by the customer meets the purchase threshold amount.

16. The computer program product of claim 15, wherein the risk factor score is based at least in part on a credit score of the customer, a frequency of visit to the vendor, a purchase history of the customer at the vendor, a participation in a rewards program of the vendor, and a pre-authorization credit limit of the customer.

17. The computer program product of claim 15, the method further comprising:
calculating, by the one or more processors of the computer system, a good will score that reflects a type of relationship between the customer and the vendor; and
facilitating, by the one or more processors of the computer system, the at least one transaction utilizing the calculated good will score.

18. The computer program product of claim 8, the method further comprising:
receiving, by the one or more processors of the computer system, the indication from a physical receptacle configured to automatically sense the presence of an item that the customer intends to purchase in the at least one transaction, the indication indicating that the item was placed in the physical receptacle; and
transmitting, by the one or more processors of the computer system, the notification to a display on the physical receptacle in the form of a visible indicator viewable by the customer and employees of the vendor.

19. The computer program product of claim 15, the method further comprising:
receiving, by the one or more processors of the computer system, a second indication that the physical receptacle is crossing a sensed threshold at the vendor;
initiating, by the one or more processors of the computer system, a payment authorization cycle in response to the receiving the second indication that the physical receptacle is crossing the sensed threshold; and
transmitting, by the one or more processors of the computer system, a second notification related to the status of the payment authorization cycle.

20. The computer program product of claim 15, the method further comprising:
determining, by the one or more processors of the computer system, that the at least one transaction intended to be made by the customer meets the purchase threshold amount;
finalizing, by the one or more processors of the computer system, the at least one transaction; and
verifying, by the one or more processors of the computer system, an identity of the customer using information received by an identity sensing system.
